(19) United States
(12) Patent Application Publication
(10) Pub. No.: US 2019/0049889 A1
(43) Pub. Date: Feb. 14, 2019

(54) IMAGE FORMING APPARATUS

(71) Applicant: CANON KABUSHIKI KAISHA, Tokyo (JP)

(72) Inventor: Rin Ishikawa, Ushiku-shi (JP)

(21) Appl. No.: 16/043,439

(22) Filed: Jul. 24, 2018

(30) Foreign Application Priority Data
Aug. 9, 2017 (JP) 2017-154609

(51) Int. Cl. G03G 15/00; G03G 15/08

(52) U.S. Cl. CPC G03G 15/556; G03G 15/0886

(57) ABSTRACT

An image forming apparatus includes a detection unit, a supporting portion, a shutter, an opposing portion, and a regulating portion. The shutter is configured to move between a first position and a second position with respect to the supporting portion. The second position is a position where an opening portion retracts from a detection surface of the detection unit and the shutter covers the detection surface. The regulating portion comprises a wall portion that protrudes from the opposing portion toward the shutter and that contacts an edge portion of the opening portion when the shutter is positioned at the second position. The wall portion is extending from a first end side to a second end side of the opening portion with respect to a width direction intersecting with an opening and closing direction of the shutter.

### BACKGROUND OF THE INVENTION

### Field of the Invention

The present invention relates to image forming apparatuses such as copying machines, printers and facsimile devices that adopt an electrophotographic system or an electrostatic recording system.

### Description of the Related Art

Heretofore, image forming apparatuses adopting an electrophotographic system are applied widely as copying machines, printers, plotters, facsimile, and a multifunction device equipped with a plurality of these functions. Some of these types of image forming apparatuses adopt a system where a toner image formed on an image bearing member such as a photosensitive drum is primarily transferred to an intermediate transfer body, and thereafter, the primarily transferred toner image is secondarily transferred to a recording medium. For example, an intermediate transfer belt is used as the intermediate transfer body, and the toner image formed on the image bearing member is primarily transferred to an intermediate transfer belt being rotated. This process is repeatedly performed for predetermined colors, such as yellow (Y), magenta (M), cyan (C) and black (Bk), to realize superposed transfer. By performing such superposed transfer, a color image is formed.

In this type of image forming apparatus, a control toner image, i.e., patch image, having a predetermined shape is formed on the intermediate transfer belt by image forming units of respective colors, and the control toner image is detected by an optical sensor having a light emitting component and a photosensing portion to compute an amount of misregistration of each color. Thereby, registration correction, hereinafter referred to as color registration correction, in which the image forming position is corrected, and density correction, in which an amount of correction is computed based on a difference between a light amount reflected from a density reference member and a light amount reflected from the control toner image for density correction, are performed.

Since both color registration correction and density correction are performed by reading the reflected light amount from the control toner image and computing the correction amount, if detection surface of the optical sensor serving as the sensing unit is soiled by foreign substances such as paper dust and toner, the reflected light amount may not be read accurately. Thus, erroneous detection may be increased or detection variation may become greater, influencing image quality or causing color shift and unevenness of density.

In order to solve such problems, an image forming apparatus equipped with a protection shutter having a detection hole and configured to move with respect to an optical sensor for reading a control toner image for image correction has been developed (refer to Japanese Patent Application Laid-Open Publication No. 2002-131997). In the image forming apparatus, if the optical sensor is used, the protection shutter is set to an opened state where the detection hole is positioned on an optical path of the sensor, but if the optical sensor is not used, the protection shutter is set to a closed state where the portion of the protection shutter without the detection hole is positioned on the optical path of the sensor. By moving the sensor cover, the detection surface of the optical sensor can be covered to reduce soiling when the optical sensor is not used, so that erroneous detection and detection variation caused by soiling of the detection surface of the optical sensor can be suppressed.

According further to the image forming apparatus, a scraper formed of a PET film configured to contact the detection surface is provided on a side surface of the protection shutter opposed to the detection surface of the optical sensor, and in a state where the protection shutter is opened and closed, the scraper slides against and cleans the detection surface. Thereby, the soiling of the detection surface of the optical sensor can be suppressed more effectively, and erroneous detection and detection variation caused by soiling of the detection surface can be reduced.

However, according to the image forming apparatus disclosed in the above-described Japanese Patent Application Laid-Open Publication No. 2002-131997, a scraper which is an independent member is attached to the protection shutter, so that the number of components is increased, leading to increase in size of the image forming apparatus. In contrast, a configuration may be considered where a distance between the detection hole of the protection shutter in the closed state and the detection surface of the optical sensor are extended by increasing the amount of movement of the protection shutter being opened and closed, without providing an independent member such as a scraper on the protection shutter. According to this configuration, amount of paper dust entering through the detection hole and reaching the detection surface can be reduced. However, according to this configuration, the size of the image forming apparatus will be increased.

The present invention provides an image forming apparatus configured to suppress soiling of the optical sensor without causing increase of number of components and increase in size.

### SUMMARY OF THE INVENTION

According to a first aspect of the present invention, an image forming apparatus includes a detection unit configured to detect a predetermined toner image that is formed on an image bearing member, a supporting portion configured to support the detection unit, a shutter having an opening portion for exposing a detection surface of the detection unit and configured to move between a first position and a second position with respect to the supporting portion, the first position being a position where the opening portion opposes to the detection surface and the detection unit detects the predetermined toner image, and the second position being a position where the opening portion retracts from the detection surface and the shutter covers the detection surface, an opposing portion provided on the supporting portion and configured to oppose to the opening portion in a state where the shutter is positioned at the second position, and a regulating portion provided on the supporting portion and configured to be in contact with the shutter and regulate movement of the shutter in a closing direction. The regulating portion comprises a wall portion that protrudes from the opposing portion toward the shutter and that contacts an edge portion of the opening portion in a state where the shutter is positioned at the second position, the wall portion extending from a first end side to a second end side of the opening portion with respect to a width direction intersecting with an opening and closing direction of the shutter.

According to a second aspect of the present invention, an image forming apparatus includes a detection unit configured to detect a predetermined toner image that is formed on an image bearing member, a supporting portion configured to support the detection unit, an exposing portion disposed on the supporting portion and configured to expose a detection surface of the detection unit, a shutter having an opening portion for exposing a detection surface of the detection unit and configured to move between a first position and a second position with respect to the supporting portion, the first position being a position where the opening portion opposes to the detection surface and the detection unit detects the predetermined toner image, and the second position being a position where the opening portion retracts from the detection surface and the shutter covers the detection surface, and a regulating portion provided on the shutter and configured to be in contact with the supporting portion and regulate movement of the shutter in a closing direction in a state where the shutter is positioned at the second position. The regulating portion comprises a wall portion that protrudes from the shutter to a side of the detection unit and that contacts an edge portion of the exposing portion in a state where the shutter is positioned at the second position, the wall portion extending from a first end side to a second end side of the opening portion with respect to a width direction intersecting with an opening and closing direction of the shutter.

Further features of the present invention will become apparent from the following description of exemplary embodiments with reference to the attached drawings.

### BRIEF DESCRIPTION OF THE DRAWINGS

FIG. 1 is a cross-sectional view illustrating a general configuration of an image forming apparatus according to an embodiment.

FIG. 2 is a perspective view of a general configuration of a unit of an image forming apparatus according to the embodiment.

FIG. 3 is a perspective view illustrating a portion of a support frame of the unit of the image forming apparatus according to the embodiment.

FIG. 4 is a front view of a general configuration of the unit of the image forming apparatus according to the embodiment.

FIG. 5A is a perspective view of a registration patch sensor illustrating a general configuration of an optical sensor stored in the unit of the image forming apparatus according to the embodiment.

FIG. 5B is a side view of the registration patch sensor illustrating the general configuration of the optical sensor stored in the unit of the image forming apparatus according to the embodiment.

FIG. 5C is a perspective view of the registration sensor illustrating the general configuration of the optical sensor stored in the unit of the image forming apparatus according to the embodiment.

FIG. 5D is a side view of the registration sensor illustrating the general configuration of the optical sensor stored in the unit of the image forming apparatus according to the embodiment.

FIG. 6A is a front view of an opened state, i.e., first position, of the shutter, illustrating the registration patch sensor of the image forming apparatus according to the embodiment.

FIG. 6B is a front view illustrating a closed state, i.e., second position, of the shutter, illustrating the registration patch sensor of the image forming apparatus according to the embodiment.

FIG. 7A is a front view of the opened state, i.e., first position, of the shutter, in which an opening portion of the shutter for the registration patch sensor of the image forming apparatus according to the embodiment is shown in enlarged view.

FIG. 7B is a front view of the closed state, i.e., second position, of the shutter, in which the opening portion of the shutter for the registration patch sensor of the image forming apparatus according to the embodiment is shown in enlarged view.

FIG. 8A is a perspective view of the opened state, i.e., first position, of the shutter illustrating the registration patch sensor of the image forming apparatus according to the embodiment.

FIG. 8B is a perspective view of the closed state, i.e., second position, of the shutter illustrating the registration patch sensor of the image forming apparatus according to the embodiment.

FIG. 9A is a front view of the opened state, i.e., first position, of the shutter, in which the opening portion of the shutter for the registration sensor in the image forming apparatus according to the embodiment is shown in enlarged view.

FIG. 9B is a front view of the closed state, i.e., second position, of the shutter, in which the opening portion of the shutter for the registration sensor in the image forming apparatus according to the embodiment is shown in enlarged view.

FIG. 10A is a front view of the opened state, i.e., first position, of the shutter, in which the opening portion of the shutter for the registration patch sensor in a modified example of the image forming apparatus according to the embodiment is shown in enlarged view.

FIG. 10B is a front view of the closed state, i.e., second position, of the shutter, in which the opening portion of the shutter for the registration patch sensor in a modified example of the image forming apparatus according to the embodiment is shown in enlarged view.

FIG. 11A is a front view of the opened state, i.e., first position, of the shutter, in which the opening portion of the shutter for the registration patch sensor in another modified example of the image forming apparatus according to the embodiment is shown in enlarged view.

FIG. 11B is a front view of the closed state, i.e., second position, of the shutter, in which the opening portion of the shutter for the registration patch sensor in another modified example of the image forming apparatus according to the embodiment is shown in enlarged view.

### DESCRIPTION OF THE EMBODIMENTS

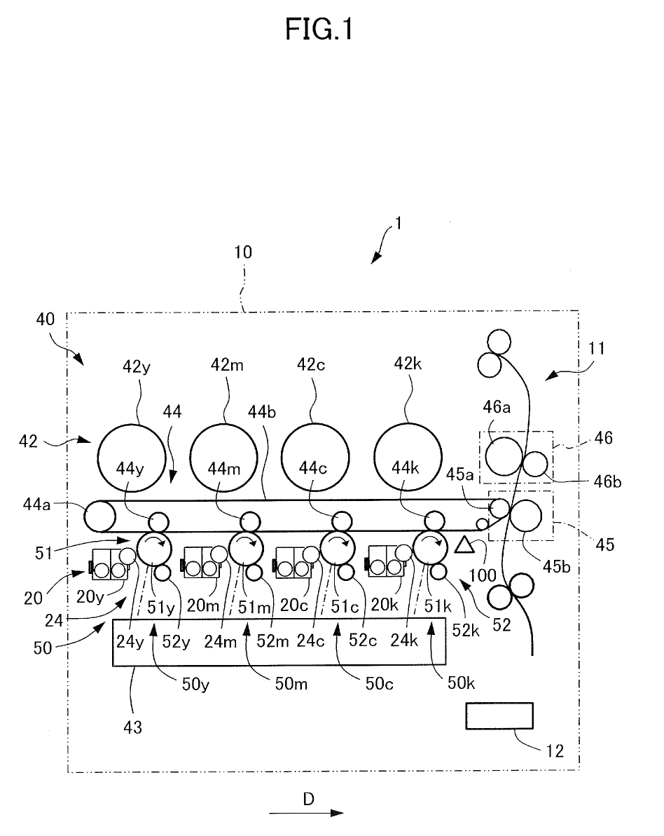

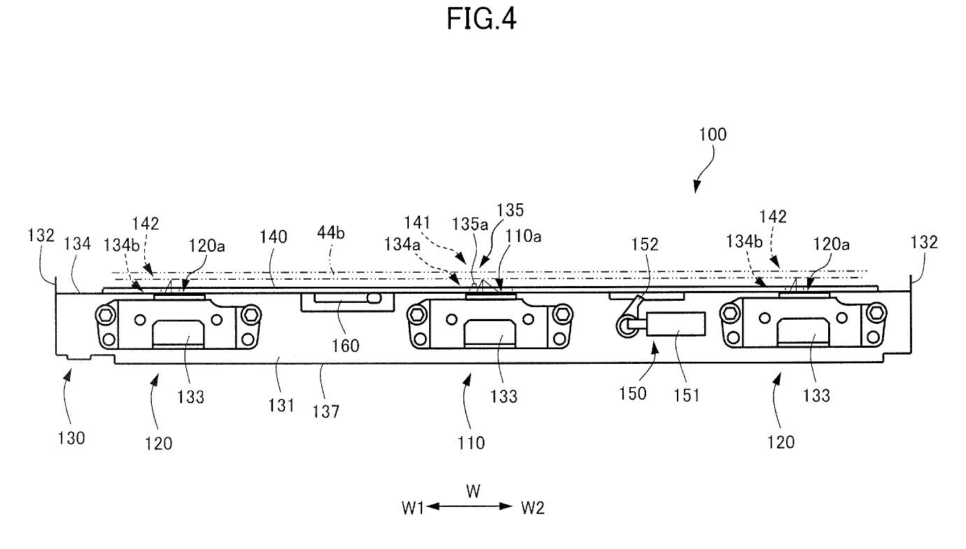

Now, a preferred embodiment of the present invention will be described in detail with reference to FIGS. 1 through 11B. The present embodiment illustrates a tandem-type full-color printer as an example of an image forming apparatus 1. However, the present invention can be applied to an image forming apparatus adopting a system other than the tandem-type image forming apparatuses 1, and it can be monochrome or mono-color printing instead of full color printing. The present invention can be implemented for various purposes as printers, various printing machines, copying machines, facsimiles, multifunction devices and so on. Further according to the present embodiment, a two-component developer composed of nonmagnetic toner and magnetic carrier can be used as developer.

As illustrated in FIG. 1, the image forming apparatus 1 includes an image forming apparatus body, hereinafter referred to as apparatus body, 10. The apparatus body 10 includes an image reading unit and a sheet feeding unit not shown, an image forming unit 40, a sheet conveyance unit 11, a sheet discharge portion not shown, and a control unit 12. The image forming apparatus 1 is configured to form a four-color full-color image on a recording material according to image signals from an image reading unit, a host device such as a personal computer, or an external device such as a digital camera or a smartphone. The sheet S serving as recording material has a toner image formed thereto, and actual examples of the sheet include normal paper, resin sheet as substitute of normal paper, thick paper, and OHP sheet.

The image forming unit 40 includes a drum cartridge 50, a developing unit 20, a toner container 42, a laser scanner 43, an intermediate transfer unit 44, a secondary transfer portion 45, and a fixing unit 46. The image forming unit 40 is configured to form an image on a sheet S based on image information. The image forming apparatus 1 according to the present embodiment corresponds to full-color printing, and drum cartridges 50y, 50m, 50c and 50k are respectively provided with a similar configuration for each of the four toner colors of yellow (y), magenta (m), cyan (c) and black (k). Toner containers 42y, 42m, 42c and 42k are also respectively provided with a similar configuration for each of the four toner colors of yellow (y), magenta (m), cyan (c) and black (k). Therefore, in FIG. 1, a color identifier is added to the reference numbers in the configurations of the four colors, but there are cases where only the reference number is provided without the color identifier attached to the reference number in the specification.

The toner container 42 is a cylindrical bottle, for example, in which toner is stored, and the toner container 42 is arranged above each drum cartridge 50 with a toner hopper not shown coupled thereto. The laser scanner 43 exposes the surface of a photosensitive drum 51 charged by a charging roller 52 and forms an electrostatic latent image on the surface of the photosensitive drum 51.

The drum cartridge 50 is a photosensitive member unit formed as an integrated unit, and it is attached in a detachable manner to the apparatus body 10. The drum cartridge 50 includes a photosensitive drum 51 configured to bear a toner image and rotate, a charging roller 52, and a cleaning blade not shown. The photosensitive drum 51, the charging roller 52, the developing unit 20 and a developing sleeve 24 are respectively provided with a similar configuration for each of the four colors of yellow (y), magenta (m), cyan (c) and black (k).

The photosensitive drum 51 includes a photosensitive layer formed to have negative charged polarity on an outer circumference surface of an aluminum cylinder, and rotates at a predetermined processing speed, i.e., peripheral speed. The charging roller 52 contacts the surface of the photosensitive drum 51 and charges the surface of the photosensitive drum 51 to uniform negative dark potential, for example. After charging, an electrostatic image is formed on the photosensitive drum 51 by the laser scanner 43 based on image information. The photosensitive drum 51 bears the formed electrostatic image and moves in circulating motion, and the image is developed using toner by the developing sleeve 24 of the developing unit 20. The developed toner image is primarily transferred to an intermediate transfer belt 44b described later. After primary transfer, the surface of the photosensitive drum 51 is destaticized by a pre-exposure unit not shown.

The intermediate transfer unit 44 is arranged above the drum cartridges 50y, 50m, 50c and 50k. The intermediate transfer unit 44 includes a plurality of rollers such as a drive roller 44a, a driven roller and primary transfer rollers 44y, 44m, 44c and 44k, and an intermediate transfer belt, i.e., image bearing member, 44b that is wound around these rollers. The primary transfer rollers 44y, 44m, 44c and 44k are respectively arranged to oppose to the photosensitive drums 51y, 51m, 51c and 51k, contact the intermediate transfer belt 44b, and primarily transfer the toner image on the photosensitive drum 51 to the intermediate transfer belt 44b.

A toner image formed on the photosensitive drum 51 is primarily transferred at a primary transfer portion to the intermediate transfer belt 44b by applying primary transfer bias. The secondary transfer portion 45 includes a secondary transfer inner roller 45a and a secondary transfer outer roller 45b, and by applying secondary transfer bias at the nip portion between the secondary transfer outer roller 45b and the intermediate transfer belt 44b, the toner image on the intermediate transfer belt 44b is secondarily transferred to the sheet S. The fixing unit 46 includes a fixing roller 46a and a pressing roller 46b, and in a state where the sheet S is nipped between the fixing roller 46a and the pressing roller 46b and conveyed, the toner image transferred to the sheet S is heated, pressed and fixed to the sheet S.

A registration patch sensor unit 100 is provided between the black drum cartridge 50k and the secondary transfer outer roller 45b, opposing to the surface of the intermediate transfer belt 44b. The detailed configuration of the registration patch sensor unit 100 will be described later.

The control unit 12 is composed of a computer, and includes, for example, a CPU, a ROM configured to store programs for controlling respective units, a RAM configured to temporarily store data, and an input output circuit configured to input and output signals with the exterior. The CPU is a microprocessor that administrates the overall control of the image forming apparatus 1, and it is a main body of a system controller. The CPU is connected via an input output circuit to an image reading unit, a sheet feeding unit, an image forming unit 40, a sheet conveyance unit 11 and a control unit, and the CPU is configured to communicate signals with the respective units and control operations thereof.

Next, we will describe an image forming operation in the image forming apparatus 1 configured as described.

When the image forming operation is started, the photosensitive drum 51 is rotated and the surface is charged by the charging roller 52. Then, laser beams are irradiated to the photosensitive drum 51 based on the image information from the laser scanner 43, and an electrostatic latent image is formed on the surface of the photosensitive drum 51. The electrostatic latent image is developed by having toner attach to the image at the developing unit 20, by which the image is visualized as toner image and transferred to the intermediate transfer belt 44b.

Meanwhile, the sheet feeding unit is operated in parallel with the toner image forming operation, and at a matched timing with the toner image on the intermediate transfer belt 44b, the sheet S is conveyed to the secondary transfer portion 45. Further, image is transferred from the intermediate transfer belt 44b to the sheet S, and the sheet S is conveyed to the fixing unit 46, where non-fixed toner image is heated, pressed and fixed to the surface of the sheet S, before the sheet S is discharged from the apparatus body 10.

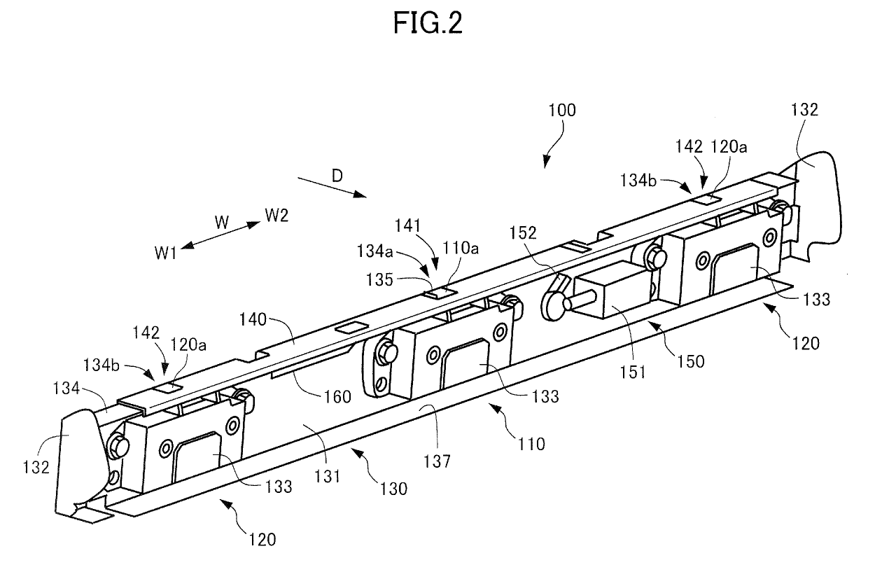

Next, the configuration of a registration patch sensor unit, hereinafter referred to as unit, 100 will be described in detail with reference to FIGS. 2 through 9A. As illustrated in FIGS. 2 to 4, the unit 100 includes one registration patch sensor, serving as first detection unit, 110, two registration sensors, serving as second detection units, 120, a support frame 130, a shutter 140, and a shutter movement mechanism 150. In the present embodiment, the direction in which the intermediate transfer belt 44b opposing to the unit 100 moves is referred to as a movement direction D, and the direction horizontally orthogonal to the movement direction D is referred to as a width direction W. In the width direction W, a front direction of the apparatus body 10 is referred to as a first direction W1 and a depth direction is referred to as a second direction W2.

The support frame 130 is arranged so that its longitudinal direction corresponds to the width direction W of the intermediate transfer belt 44b. The support frame 130 includes a flat plate-shaped body portion, serving as supporting portion, 131 that is arranged upright, a fixing portion 137 provided on a lower edge portion of the body portion 131, and an opposing portion 134 provided on an upper edge portion of the body portion 131. The fixing portion 137 is formed in a flange shape extended horizontally from the lower edge of the body portion 131. The opposing portion 134 is formed in a flange shape extended horizontally from the upper edge portion of the body portion 131. That is, the support frame 130 is formed to have an approximately U-shaped cross-section, that is, a channel-like cross-section, by the body portion 131, the fixing portion 137 and the opposing portion 134. Further, the support frame 130 includes an attaching portion 132 provided upright and orthogonal to both end portions in the width direction W of the body portion 131, and a holder portion 133 provided on the body portion 131.

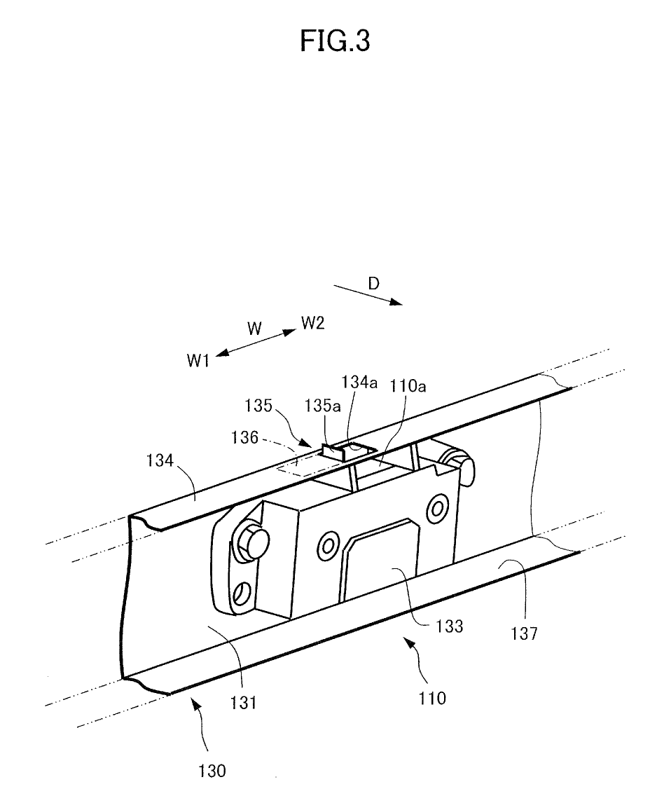

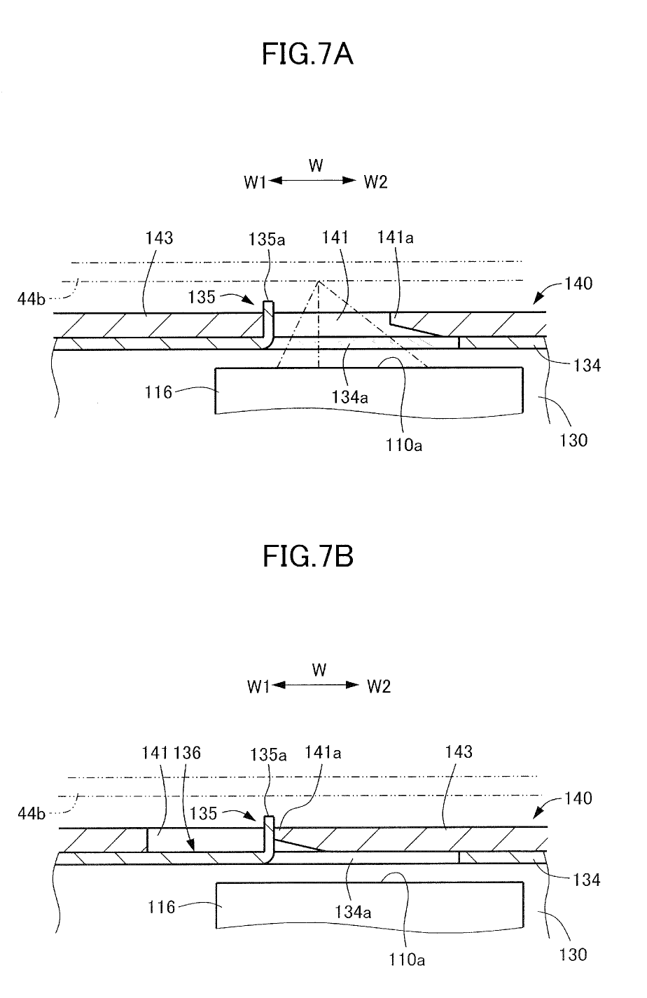

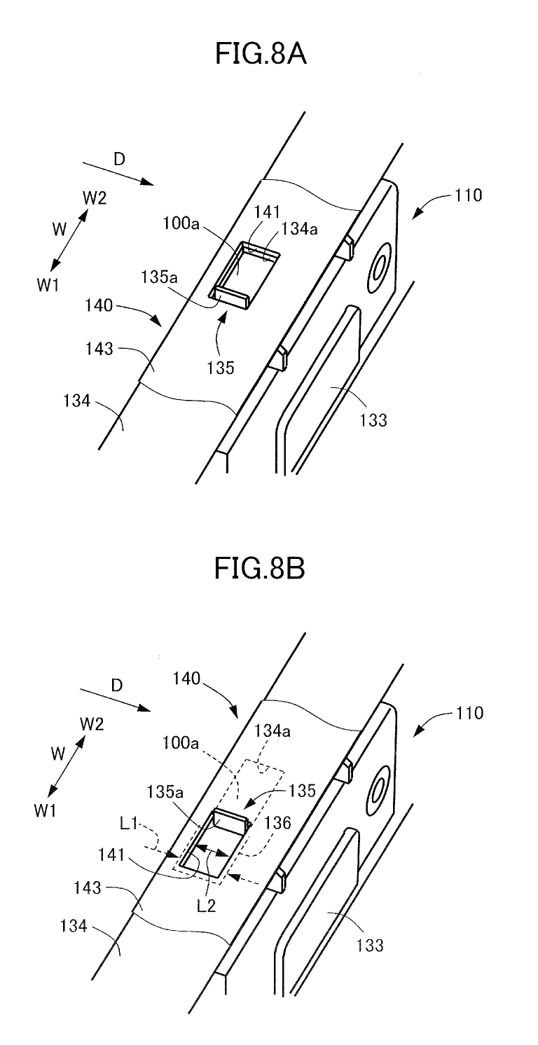

Here, the opposing portion 134 is arranged to oppose to the shutter 140 on the body portion 131 and slidably supports the shutter 140. Further, as illustrated in FIG. 3, the opposing portion 134 includes a cover portion 136, a first through hole, serving as a first exposing portion, 134a and a second through hole, serving as a second exposing portion, 134b (refer to FIG. 2). The cover portion 136 is arranged at a position opposed to a first opening portion 141 of the shutter 140 in a state where the shutter 140 is positioned at a second position, i.e., closed position, and covers at least a part of the first opening portion 141 (refer to FIG. 8B). Further, the cover portion 136 includes a contact portion, serving as a regulating portion, 135. The contact portion 135 includes a protruded portion, serving as a wall portion, 135a that protrudes to be inserted to the first opening portion 141 of the shutter 140. In a state where the contact portion 135 positions the shutter 140 at the second position, the contact portion 135 contacts an edge portion 141a of the first opening portion 141 arranged upstream in a closing direction of the shutter 140 and positions the shutter 140 at the second position (refer to FIG. 7B). As illustrated in FIG. 2, in a state where the shutter 140 is positioned at the first position, the first through hole 134a exposes a detection surface 110a of the registration patch sensor 110. The second through hole 134b exposes a detection surface 120a of a registration sensor 120. We will describe the cover portion 136 and the contact portion 135 later.

The unit 100 is positioned and supported on the apparatus body 10 by having the attaching portion 132 on the second direction W2 side of the support frame 130 urged to a positioning portion not shown provided on the apparatus body 10. In the present embodiment, the registration patch sensor 110 is arranged at the center portion with respect to the width direction W of the intermediate transfer belt 44b, and the registration sensors 120 are arranged at both end portions thereof. According further to the present embodiment, the unit 100 includes one registration patch sensor 110 and two registration sensors 120, but the configuration of the unit 100 is not restricted thereto, and other configurations can be adopted.

The registration patch sensor 110 and the registration sensors 120 are retained by the holder portion 133 of the support frame 130 to be fixed and supported on the support frame 130. That is, the support frame 130 supports the registration patch sensor 110 and the registration sensors 120. The registration patch sensor 110 and the registration sensors 120 are disposed so that the detection surface 110a of the registration patch sensor 110 and the detection surfaces 120a of the registration sensors 120 are respectively opposed to the surface of the intermediate transfer belt 44b. The registration patch sensor 110 and the registration sensors 120 are arranged so that the distance between the intermediate transfer belt 44b and the respective detection surfaces 110a and 120a is maintained to a fixed distance, such as approximately 6 mm.

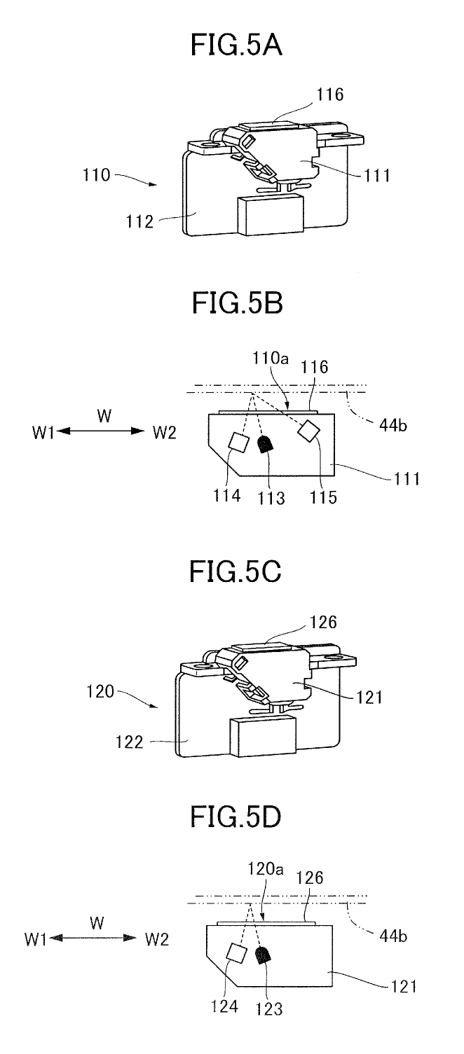

As illustrated in FIGS. 5A and 5B, the registration patch sensor 110 is an optical sensor, and includes a casing 111, a base plate 112, a light source 113, a regular reflection photosensing portion 114, a diffused reflection photosensing portion 115, and a sensor cover 116. The casing 111 stores the base plate 112, the light source 113, the regular reflection photosensing portion 114 and the diffused reflection photosensing portion 115. The light source 113, the regular reflection photosensing portion 114 and the diffused reflection photosensing portion 115 are mounted on the base plate 112. The light source 113 is an LED light source. The regular reflection photosensing portion 114 is a photodiode, for example, and receives regular reflection light reflected from the intermediate transfer belt 44b. The diffused reflection photosensing portion 115 is a photodiode, for example, and receives diffused reflection light reflected from the intermediate transfer belt 44b. The sensor cover 116 is formed of transparent acrylic resin, for example, having a Fresnel lens formed on the surface to collect light. The sensor cover 116 is arranged to be perpendicular to the mounting surface of the base plate 112. The surface of the sensor cover 116 opposed to the intermediate transfer belt 44b is set as the detection surface 110a of the registration patch sensor 110.

As illustrated in FIGS. 5C and 5D, the registration sensor 120 is an optical sensor, and includes a casing 121, a base plate 122, a light source 123, a regular reflection photosensing portion 124 and a sensor cover 126. The casing 121 stores the base plate 122, the light source 123 and the regular reflection photosensing portion 124. The detection surface 120a of the registration sensor 120 is set as the surface of the sensor cover 126 opposed to the intermediate transfer belt 44b. The configuration of the registration sensor 120 is similar to the registration patch sensor 110 except that the registration sensor 120 does not have a diffused reflection photosensing portion, so the detailed description thereof will be omitted.

Now, the process of performing color registration correction and density correction using the unit 100 according to the image forming apparatus 1 of the present embodiment will be described. The registration patch sensor 110 and the registration sensors 120 are arranged approximately at even intervals in the width direction W of the intermediate transfer belt 44b and detect the toner image formed on the intermediate transfer belt 44b. The registration patch sensor 110 is used for color registration correction and density correction, and the registration sensors 120 are used for color registration correction. In color registration correction, a reference toner image for color registration correction of each color is detected, and amount of misregistration with respect to yellow, which is the reference color according to the present embodiment, is computed and correction is performed. In density correction, a reference toner image for density correction is detected and correction is performed. The reference toner image for color registration correction and the reference toner image for density correction correspond to the predetermined toner image, i.e., the control toner image, and in the present specification, they are generally referred to as reference toner image for correction.

In order to perform image correction, as illustrated in FIG. 1, the laser scanner 43 forms a correction reference pattern for each color on the respective surfaces of the photosensitive drums 51 as electrostatic latent image. The formed electrostatic latent image is actualized as reference toner image for correction by the developing unit 20. The toner images on the photosensitive drums 51y, 51m, 51c and 51k are sequentially primarily transferred to the intermediate transfer belt 44b by applying predetermined pressure and electrostatic load bias through the primary transfer rollers 44y, 44m, 44c and 44k. The reference toner image for correction primarily transferred to the intermediate transfer belt 44b is detected by the registration patch sensor 110 and the registration sensors 120. The detected information of reference toner image for correction is processed by the control unit 12 to compute the correction amount of color registration correction and density correction, and feedback is performed to the output image based on the computed correction amount.

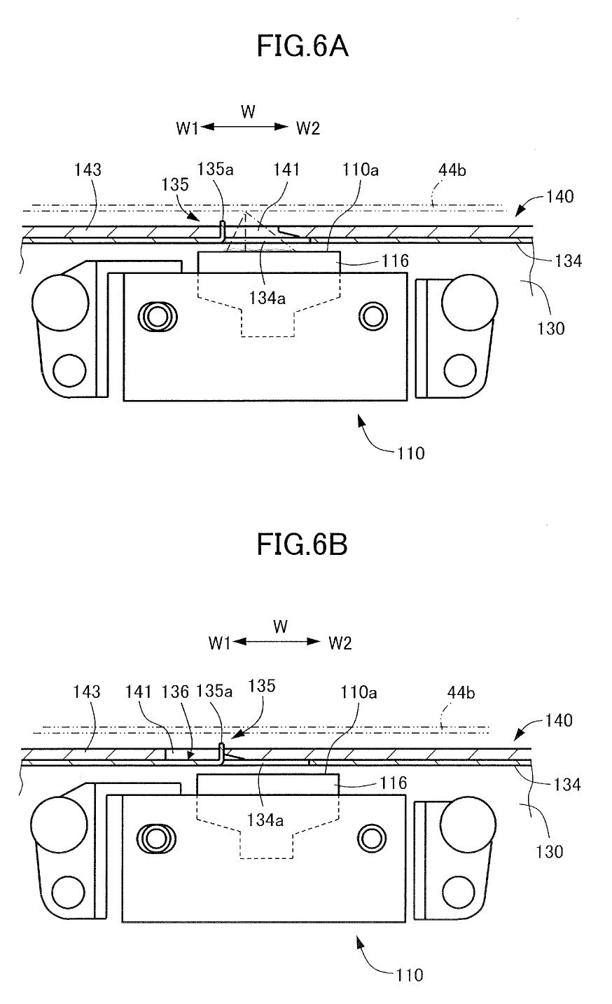

Next, with respect to the configuration regarding the shutter 140 of the image forming apparatus 1 according to the present embodiment, a portion of the registration patch sensor 110 opposed to the detection surface 110a will be described in detail with reference to FIGS. 6A through 8B. The opposing portion 134 of the support frame 130 is parallel to the intermediate transfer belt 44b and supports the shutter 140 slidably. The first through hole 134a that passes through the opposing portion 134 is formed on the opposing portion 134 at a position opposed to the detection surface 110a. The contact portion 135 protruded toward the intermediate transfer belt 44b is formed at the edge portion on the first direction W1 side of the first through hole 134a with respect to the width direction W. In the present embodiment, the contact portion 135 is formed by bending the edge portion on the first direction W1 side of the first through hole 134a toward the intermediate transfer belt 44b. Further, the opposing portion 134 has a plate-like shape that opposes to the shutter 140. The opposing portion 134 includes the cover portion 136 that at least partially covers the first opening portion 141 at a position opposed to the first opening portion 141 disposed on the shutter 140 in a state where the shutter 140 is at a closed position.

The shutter 140 is approximately plate-shaped and disposed on an upper surface of the opposing portion 134. The shutter 140 includes a first opening portion, i.e., opening portion, 141, second opening portions 142, and a non-opened portion 143. The first opening portion 141 is provided to pass through the shutter 140 and expose the detection surface 110a at a position configured to oppose to the detection surface 110a. The non-opened portion 143 is provided not to pass through the shutter 140 and to block light and flow of paper dust between spaces on both sides of the shutter 140. The second opening portions 142 are provided to pass through the shutter 140 at positions configured to oppose to the detection surfaces 120a of the registration sensors 120, the detailed description of which will be described later.

The shutter 140 is movable in the width direction W with respect to the support frame 130 between the first position, i.e., opened position, and the second position, i.e., closed position. That is, the width direction W corresponds to a direction of movement of the shutter 140. As illustrated in FIGS. 6A, 7A and 8A, the first position of the shutter 140 is a position where the first opening portion 141 opposes to the detection surface 110a so that the detection surface 110a is exposed in an opened state, and that the reference toner image for correction is detectable. In this state, the first opening portion 141 and the first through hole 134a are positioned in an overlapped manner with respect to the detection surface 110a, and light irradiated from the light source 113 forms an image on the surface of the intermediate transfer belt 44b through the detection surface 110a. The regular reflection light and diffused reflection light reflected on the intermediate transfer belt 44b are received by the respective photosensing portions 114 and 115. Thereby, the reference toner image for correction on the intermediate transfer belt 44b is detected and used for color registration correction and density correction to realize image correction.

As illustrated in FIGS. 6B, 7B and 8B, the second position of the shutter 140 is a position where the non-opened portion 143 covers the detection surface 110a and realizes a closed state. In this state, the first opening portion 141 is positioned at a displaced position with respect to the detection surface 110a and the non-opened portion 143 is positioned in an overlapped manner with respect to the detection surface 110a, so that the detection surface 110a is covered by the non-opened portion 143. Further, in a state where the shutter 140 is at the second position, i.e., closed position, the first opening portion 141 is at a position retracted from the detection surface 110a, but foreign substances such as paper dust may reach the detection surface 110a through the first opening portion 141. Therefore, in a state where the shutter 140 is at the second position, i.e., closed position, the path from the first opening portion 141 to the detection surface 110a is covered by the cover portion 136 provided on the opposing portion 134 and the contact portion 135 protruded from the opposing portion 134. Therefore, in a state where the shutter 140 is at the closed position, the amount of entry of paper dust can be reduced by the shutter 140 covering the detection surface 110a by the non-opened portion 143 and the opposing portion 134 covering the path from the first opening portion 141 to the detection surface 110a by the cover portion 136 and the contact portion 135. According to the present embodiment, in a state where the shutter 140 is at the closed position, it is preferable that 90% or greater of the area of the first through hole 134a is covered. Similarly, in a state where the shutter 140 is at the closed position, it is preferable that 90% or greater of the area of the first opening portion 141 is covered by the cover portion 136 of the opposing portion 134.

Therefore, as illustrated in FIG. 8B, the width of the cover portion 136 is set to L1 and the width of the first opening portion 141 is set to L2 with respect to the width direction, that is, the upstream-downstream direction of the intermediate transfer belt 44b in the movement direction D, that is orthogonal to the movement direction, i.e., width direction W, of the shutter 140. In this case, according to the present embodiment, L1 is set to be greater than L2. Therefore, in a state where the shutter 140 is positioned at the closed position, the first opening portion 141 will be covered with respect to the width direction, that is, the upstream-downstream direction of the intermediate transfer belt 44b in the movement direction D, by the opposing portion 134.

As illustrated in FIG. 7A, the contact portion 135 is designed to be inserted to the first opening portion 141 of the shutter 140, and in a state where the shutter 140 is positioned at the second position, the contact portion 135 performs positioning by being in contact with the edge portion 141a of the first opening portion 141. That is, the edge portion 141a of the first opening portion 141 on the second direction W2 side, that is, the upstream side in the shutter closing direction, is configured to be in contact with the contact portion 135, and positions the shutter 140 at the second position by being in contact with the contact portion 135. Thus, in a state where the shutter 140 is at the closed position, the positional accuracy of the first opening portion 141 and the cover portion 136 provided on the opposing portion 134 can be ensured. According to the present embodiment, in a state where the edge portion 141a of the first opening portion 141 contacts the contact portion 135 of the support frame 130, a gap between the edge portion 141a and the contact portion 135 is closed. The contact portion 135 is designed to be inserted to the first opening portion 141 of the shutter 140, and in a state where the shutter 140 is positioned at the first position, the contact portion 135 performs positioning by being in contact with the edge portion of the first opening portion 141 on the first direction W1 side, that is, downstream side in the shutter closing direction.

Further according to the present embodiment, as illustrated in FIG. 8B, it is preferable that the gaps between both end portions of the contact portion 135 in the first opening portion 141 with respect to the movement direction D of the intermediate transfer belt 44b should preferably be 0.5 mm or smaller. That is, with respect to the width direction orthogonal to the movement direction of the shutter 140, the width of the protruded portion 135a of the contact portion 135 is smaller than the width of the first opening portion 141, and the gaps between both end portions of the protruded portion 135a and both edge portions of the first opening portion 141 are respectively 0.5 mm or smaller. Therefore, according to the present embodiment, in a state where the shutter 140 is opened and closed, gaps of 0.5 mm or smaller are formed between the first opening portion 141 and the contact portion 135 so that the first opening portion 141 does not move slidably against the contact portion 135.

According to the present embodiment, the contact portion 135 is disposed to be in contact with approximately a whole area of the edge portion of the first opening portion 141 with respect to the width direction orthogonal to the movement direction, i.e., with direction W, of the shutter 140 in a state where the edge portion of the first opening portion 141 is in contact with the contact portion 135. That is, the protruded portion 135a is extended from a first end side to a second end side of the first opening portion 141 with respect to the width direction intersecting with an opening and closing direction of the shutter 140. Therefore, the contact portion 135 not only functions as a wall portion that positions the shutter 140, but also functions as a covering wall that covers the first opening portion 141 in a state where the shutter 140 is positioned at the closed position. In the present embodiment, it is defined that the contact portion 135 functions as the covering wall in a state where the gaps between both end portions of the contact portion 135 and the edge portions of the first opening portion 141 are 0.5 mm or smaller with respect to the width direction orthogonal to direction W in a state where the contact portion 135 and the edge portion of the first opening portion 141 contact each other in direction W. Thereby, the amount of foreign substances such as paper dust reaching the detection surface 110a can be suppressed effectively.

According to the present embodiment, a tip of the contact portion 135 is arranged to protrude above the upper surface, that is, an outer surface opposite to the side facing the opposing portion 134, of the shutter 140. Thereby, toner deposited on the shutter 140 will not easily move beyond the contact portion 135 by the opening and closing motion of the shutter 140. Especially when the shutter 140 is at the closed position, the toner deposited on the opposing portion 134 opposed to the first opening portion 141 may move by the edge portion on the first direction W1 side of the first opening portion 141 of the shutter 140 when the shutter 140 moves to the opened position. Even in that case, the contact portion 135 is protruded above the upper surface of the shutter 140, so that toner moved by the opening movement of the shutter 140 can be blocked.

As illustrated in FIGS. 2 through 4, the shutter 140 is opened and closed by the shutter movement mechanism 150 and a shutter spring 160. The shutter movement mechanism 150 includes a solenoid 151 and a link 152. In a state where the solenoid 151 is turned on and attraction occurs, the shutter 140 is urged toward the second direction W2 through the link 152 and positioned at the first position to realize the opened state. In a state where the solenoid 151 is turned off and attraction does not occur, the shutter 140 is urged toward the first direction W1 by the shutter spring 160 and positioned at the second position to realize the closed state.

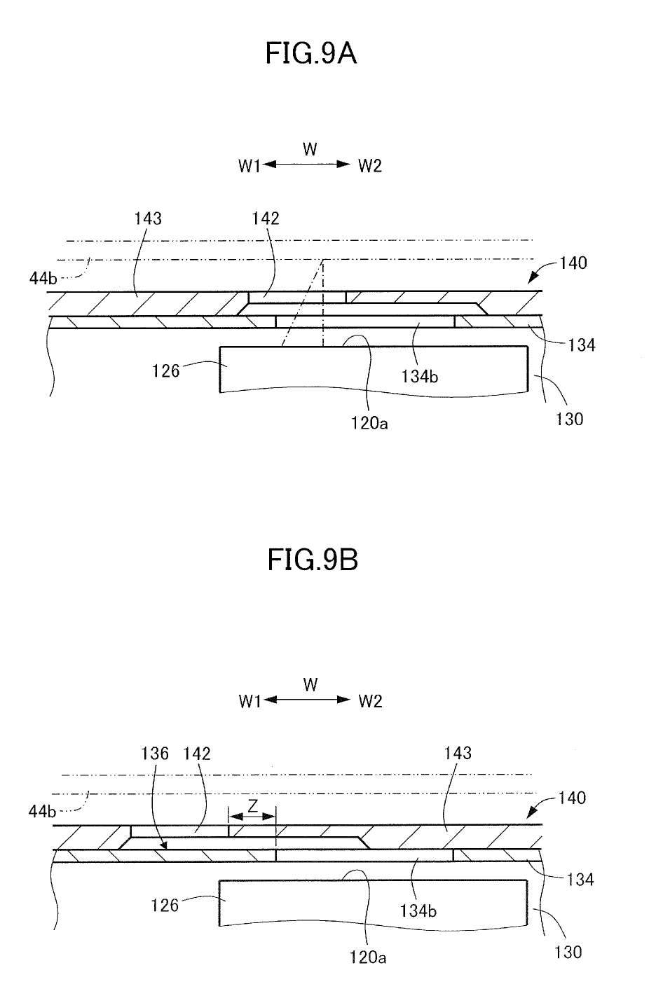

Next, a portion opposed to the detection surface 120a in the configuration of the shutter 140 of the image forming apparatus 1 according to the present embodiment will be described in detail with reference to FIGS. 9A and 9B. The second through hole 134b passing through the opposing portion 134 is formed at a position of the opposing portion 134 opposed to the detection surface 120a. The second opening portion 142 passes through the shutter 140 and is arranged at a position configured to oppose to the detection surface 120a of the registration sensor 120.

As illustrated in FIG. 9A, the first position of the shutter 140 is a position where the second opening portion 142 exposes the detection surface 120a to realize an opened state, to enable detection of the reference toner image for correction. In this state, the second opening portion 142 and the second through hole 134b are positioned in an overlapped manner with respect to the detection surface 120a, and light emitted from the light source 123 forms an image on the surface of the intermediate transfer belt 44b through the detection surface 120a. The regular reflection light reflected on the intermediate transfer belt 44b is received by the regular reflection photosensing portion 124. Thus, the reference toner image for correction on the intermediate transfer belt 44b is detected and used for color registration correction to realize image correction.

As illustrated in FIG. 9B, the second position of the shutter 140 is a position where the non-opened portion 143 covers the detection surface 120a to realize a closed state. In this state, the second opening portion 142 and the second through hole 134b are displaced with respect to the detection surface 120a, and the non-opened portion 143 is overlapped with the second through hole 134b with respect to the detection surface 120a, so that the detection surface 120a is covered by the non-opened portion 143. Therefore, the detection surface 120a is covered by the non-opened portion 143, and the amount of entry of paper dust can be reduced.

Now, the length in the width direction W of the first opening portion 141 and the second opening portion 142 will be described. Compared to the registration sensor 120 having only the regular reflection photosensing portion 124, the registration patch sensor 110 having both the regular reflection photosensing portion 114 and the diffused reflection photosensing portion 115 requires a wider opening area of the opening portion. Therefore, according to the present embodiment, the first opening portion 141 has a greater length in the width direction W than the second opening portion 142.

The present embodiment includes three sensors 110 and 120, and three opening portions 141 and 142 corresponding to each of the sensors 110 and 120. Therefore, it may be considerable to provide three contact portions 135 to the support frame 130 to determine the position of each of the opening portions 141 and 142. However, if contact portions 135 are respectively provided to the three opening portions 141 and 142, the two opening portions among the three opening portions may not contact the contact portions 135 due to component tolerance. If there are areas where contact does not occur, gaps may be created and foreign substances such as paper dust are likely to reach the detection surfaces 110a and 120a. Further, the first opening portion 141 is formed longer in the width direction W than the second opening portion 142.

In contrast, the amounts of movement that occur in the respective opening portions 141 and 142 by the opening and closing of the shutter 140 are the same. Therefore, as illustrated in FIG. 9B, in a state where the shutter 140 is positioned at the closed position, the second opening portion 142 is arranged at a position shifted downstream for predetermined distance Z from the second through hole 134b with respect to the first direction W1, i.e., closing direction of the shutter. That is, the distance in the width direction W between the edge portion on the second direction W2 side of the second opening portion 142 and the edge portion on the first direction W1 side of the second through hole 134b is set to predetermined distance Z. In the present embodiment, the contact portion 135 is provided only at the position to be inserted to the first opening portion 141, but since the second opening portion 142 is positioned downstream for predetermined distance Z from the second through hole 134b, the amount of entry of foreign substances such as paper dust can also be reduced at the second opening portion 142.

As described, according to the image forming apparatus 1 of the present embodiment, the contact portion 135 contacts the edge portion 141a of the first opening portion 141 and positions the shutter 140 at the second position. Therefore, in a state where the shutter 140 is positioned at the second position, the first opening portion 141 retracts from the detection surface 110a and the non-opened portion 143 covers the area opposed to the detection surface 110a. Further, the contact portion 135 blocks reach of paper dust to the detection surface, and the amount of entry of paper dust is reduced. Therefore, soiling of the registration patch sensor 110 can be suppressed without causing increase of number of components and increase in size.

According further to the image forming apparatus 1 of the present embodiment, in a state where the shutter 140 moves from the opened state to the closed state by the shutter spring 160, the edge portion 141a of the first opening portion 141 is abutted against the contact portion 135 provided on the support frame 130. Thereby, the present configuration ensures the second position of the shutter 140 in the closed state. Foreign substances such as paper dust entering through the first opening portion 141 in a state where the shutter 140 is in a closed state is deposited on the support frame 130 arranged below the first opening portion 141. The contact portion 135 functions as a covering wall that covers the paper dust and the like deposited on the support frame 130 and reduces the amount of paper dust reaching the detection surface 110a.

Further according to the image forming apparatus 1 of the present embodiment, in a state where the edge portion 141a of the first opening portion 141 contacts the contact portion 135, the gap between the edge portion 141a and the contact portion 135 is closed. Thereby, the gap between the support frame 130 and the shutter 140 is reduced, and the amount of foreign substances such as paper dust reaching the detection surface 110a is reduced. As a result, the occurrence of image defects such as color shift and unevenness of density caused by the registration patch sensor 110 being soiled and the detection accuracy being deteriorated can be prevented.

According to the image forming apparatus 1 of the present embodiment, the first opening portion 141 is formed longer in the width direction W than the second opening portion 142. The contact portion 135 is only provided at the area to be inserted to the first opening portion 141. At the first opening portion 141, entry of paper dust and the like can be suppressed by the presence of the contact portion 135 and the state of contact between the contact portion 135 and the edge portion 141a in a state where the shutter 140 is closed. Further, at the second opening portion 142, in a state where the shutter 140 is positioned at the closed position, the second opening portion 142 is arranged at a position shifted downstream for predetermined distance Z from the second through hole 134b with respect to the first direction W1, i.e., closing direction of the shutter 140. Thereby, entry of paper dust and the like at the second opening portion 142 can also be suppressed. Accordingly, in a case where a plurality of different sensors 110 and 120 are arranged, occurrence of image defects such as color shift and unevenness of density can be prevented without causing increase in size or complication of the unit 100.

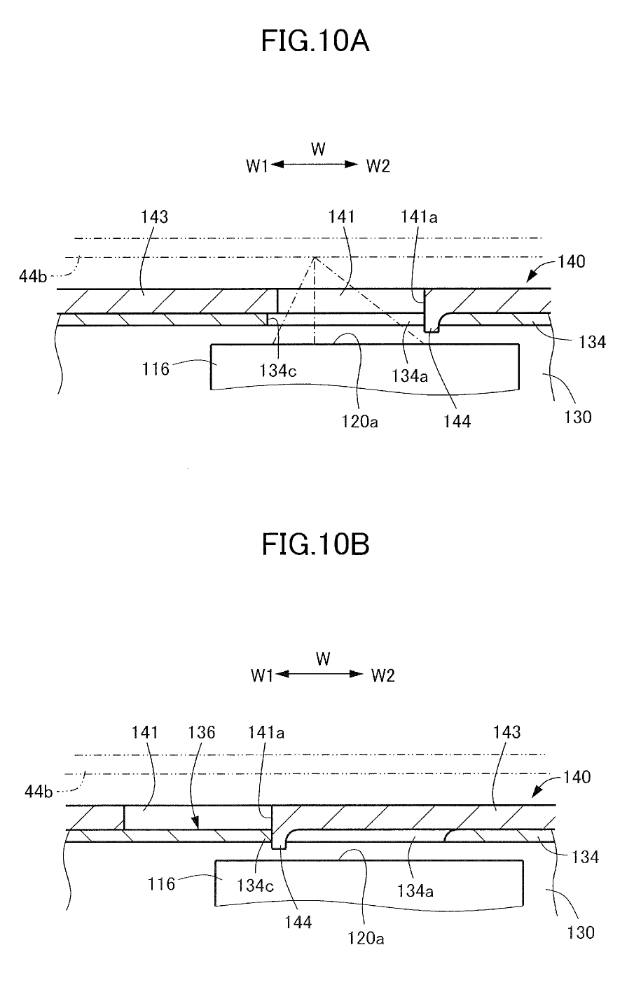

In the image forming apparatus 1 according to the above-described embodiment, an example has been illustrated where the contact portion 135 to be inserted to the first opening portion 141 is provided as the wall portion of the support frame 130, but the configuration is not restricted thereto. For example, as illustrated in FIGS. 10A and 10B, the edge portion 141a on the second direction W2 side of the first opening portion 141 of the shutter 140 may have a projected portion 144 protruded to the side of the support frame 130, and an edge portion 134c on the first direction W1 side of the first through hole 134a may be formed as the wall portion. In that case, if the shutter 140 positioned at the first position illustrated in FIG. 10A is moved and positioned at the second position as illustrated in FIG. 10B, positioning is performed by the projected portion 144 of the shutter 140 being in contact with the edge portion 134c of the first through hole 134a. Further, if the shutter 140 positioned at the second position illustrated in FIG. 10B is moved and positioned at the first position as illustrated in FIG. 10A, positioning is performed by the projected portion 144 of the shutter 140 being in contact with the edge portion on the second direction W2 side of the first through hole 134a. Even according to these cases, the width of the projected portion 144 is provided so that the projected portion 144 and the edge portion 134c are in contact with each other across approximately the whole area in the width direction orthogonal to the movement direction, i.e., width direction W, of the shutter 140. Therefore, the gap between the support frame 130 and the shutter 140 is reduced, and the amount of foreign substances such as paper dust reaching the detection surface 110a is reduced.

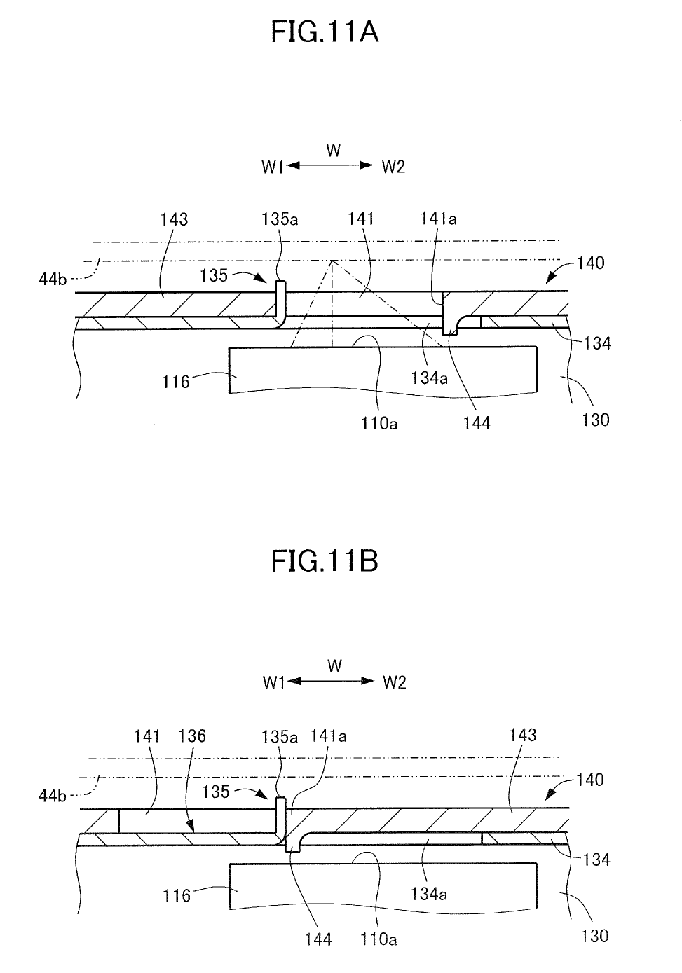

Further, the contact portion 135 illustrated in FIG. 7A and the projected portion 144 illustrated in FIG. 10A are not restricted to either one or the other, and both portions can be adopted simultaneously. For example, as illustrated in FIGS. 11A and 11B, the support frame 130 may have the contact portion 135 on the first direction W1 side of the first through hole 134a, and the shutter 140 may have the projected portion 144 on the edge portion 141a on the second direction W2 side of the first opening portion 141. In this case, if the shutter 140 positioned at the first position illustrated in FIG. 11A is moved and positioned at the second position as illustrated in FIG. 11B, positioning is performed by the projected portion 144 of the shutter 140 being in contact with the contact portion 135 of the support frame 130. Further, if the shutter 140 positioned at the second position illustrated in FIG. 11B is moved and positioned at the first position as illustrated in FIG. 11A, positioning is performed by the edge portion on the first direction W1 side of the first opening portion 141 of the shutter 140 being in contact with the contact portion 135. Even according to these cases, the projected portion 144 and the contact portion 135 contact each other through a wide area, so that the gap between the support frame 130 and the shutter 140 is further reduced, and the amount of entry of foreign substances such as paper dust on the detection surface 110a is further reduced.

According to the image forming apparatus 1 of the present embodiment, an example has been illustrated of the case where the unit 100 includes two types of optical sensors, which are the registration patch sensor 110 and the registration sensor 120, but the present invention is not restricted thereto. For example, it is also possible to adopt a configuration that includes only the registration patch sensor 110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-154609, filed Aug. 9, 2017, which is hereby incorporated by reference herein in its entirety.

What is claimed is:

1. An image forming apparatus comprising:
a detection unit configured to detect a predetermined toner image that is formed on an image bearing member;
a supporting portion configured to support the detection unit;
a shutter having an opening portion for exposing a detection surface of the detection unit and configured to move between a first position and a second position with respect to the supporting portion, the first position being a position where the opening portion opposes to the detection surface and the detection unit detects the predetermined toner image, and the second position being a position where the opening portion retracts from the detection surface and the shutter covers the detection surface;
an opposing portion provided on the supporting portion and configured to oppose to the opening portion in a state where the shutter is positioned at the second position; and
a regulating portion provided on the supporting portion and configured to be in contact with the shutter and regulate movement of the shutter in a closing direction,
wherein the regulating portion comprises a wall portion that protrudes from the opposing portion toward the shutter and that contacts an edge portion of the opening portion in a state where the shutter is positioned at the second position, the wall portion extending from a first end side to a second end side of the opening portion with respect to a width direction intersecting with an opening and closing direction of the shutter.

2. The image forming apparatus according to claim 1,
wherein in a state where the edge portion of the opening portion contacts the wall portion, a gap between the edge portion and the wall portion is closed.

3. The image forming apparatus according to claim 1,
wherein a width of the wall portion with respect to the width direction is smaller than a width of the opening portion.

4. The image forming apparatus according to claim 3,
wherein a gap between the wall portion and the opening portion with respect to the width direction is 0.5 mm or smaller.

5. The image forming apparatus according to claim 3,
wherein a width of the opening with respect to the width direction is smaller than a width of the opposing portion.

6. The image forming apparatus according to claim 3,
wherein a tip of the wall portion is arranged to protrude from an outer surface of the shutter.

7. The image forming apparatus according to claim 3,
wherein the wall portion is formed by bending the edge portion of the opposing portion to a side of the shutter.

8. The image forming apparatus according to claim 3,
wherein in a state where the shutter is positioned at the second position, 90% or greater of an area of the opening portion is covered by the opposing portion.

9. The image forming apparatus according to claim 1,
wherein with respect to a closing direction of the shutter, the edge portion on an upstream side of the opening portion comprising a protruded portion protruded to a side of the detection unit, and
wherein the wall portion contacts the protruded portion in a state where the shutter is positioned at the second position.

10. The image forming apparatus according to claim 1,
wherein the supporting portion supports the shutter slidably and moves the shutter between the first position and the second position by sliding movement.

11. The image forming apparatus according to claim 1,
wherein the detection unit is a first detection unit,
the opening portion is a first opening portion,
the image forming apparatus comprises a second detection unit configured to detect an another predetermined toner image formed on the image bearing member,
the supporting portion supports the first detection unit and the second detection unit,
the supporting portion having a first exposing portion for exposing the detection surface of the first detection unit and a second exposing portion for exposing a detection surface of the second detection unit,
the shutter comprises the first opening portion and a second opening portion that is shorter than the first opening portion with respect to a movement direction of the shutter, wherein in the first position, the first opening portion exposes the detection surface of the first detection unit and the second opening portion exposes the detection surface of the second detection unit, and in the second position, the shutter covers the respective detection surfaces of the first detection unit and the second detection unit, and
in a state where the shutter is positioned at the second position, the wall portion contacts the edge portion of the first opening portion and regulates movement of the shutter in the closing direction.

12. The image forming apparatus according to claim 11,
wherein in a state where the shutter is positioned at the second position, an upstream end of the second opening portion is positioned downstream for a predetermined distance from a downstream end of the second exposing portion with respect to the closing direction of the shutter.

13. The image forming apparatus according to claim 11,
wherein the first detection unit is a sensor comprising both a regular reflection photosensing portion and a diffused reflection photosensing portion, and
the second detection unit is a sensor comprising a regular reflection photosensing portion.

14. The image forming apparatus according to claim 11,
wherein the first detection unit is a detection unit configured to detect a predetermined toner image for density correction, and
the second detection unit is a detection unit configured to detect a predetermined toner image for registration correction.

15. The image forming apparatus according to claim 11,
wherein in a state where the shutter is positioned at the second position, 90% or greater of an area of the first exposing portion is covered by the shutter.

16. The image forming apparatus according to claim 1,
wherein the image bearing member is an intermediate transfer body configured to bear a toner image transferred from a different image bearing member and rotate.

17. An image forming apparatus comprising:
a detection unit configured to detect a predetermined toner image that is formed on an image bearing member;
a supporting portion configured to support the detection unit;
an exposing portion disposed on the supporting portion and configured to expose a detection surface of the detection unit;
a shutter having an opening portion for exposing a detection surface of the detection unit and configured to move between a first position and a second position with respect to the supporting portion, the first position being a position where the opening portion opposes to the detection surface and the detection unit detects the predetermined toner image, and the second position being a position where the opening portion retracts from the detection surface and the shutter covers the detection surface; and
a regulating portion provided on the shutter and configured to be in contact with the supporting portion and regulate movement of the shutter in a closing direction in a state where the shutter is positioned at the second position,
wherein the regulating portion comprises a wall portion that protrudes from the shutter to a side of the detection unit and that contacts an edge portion of the exposing portion in a state where the shutter is positioned at the second position, the wall portion extending from a first end side to a second end side of the opening portion with respect to a width direction intersecting with an opening and closing direction of the shutter.
